(19) United States
(12) Patent Application Publication
(10) Pub. No.: US 2012/0239291 A1
(43) Pub. Date: Sep. 20, 2012

(54) MOBILE HISTORY BASED ADAPTIVE POSITIONING MECHANISM

(75) Inventor: Ju-Yong Do, Santa Clara, CA (US)

(73) Assignee: QUALCOMM Incorporated, San Jose, CA (US)

(21) Appl. No.: 13/049,669

(22) Filed: Mar. 16, 2011

(51) Int. Cl. G01C 21/00

(52) U.S. Cl. 701/451; 701/465

(57) ABSTRACT

An apparatus, method and system for determining a position of a mobile device based on expected user mobility is presented. Expected user mobility is stored in a public and/or private model, which may be indexed and accessed using a current coarse time and/or a current rough location. The expected user mobility is updated based on historical information from previous visits. The models include grids indexed by coarse time, which is a periodic duration, and/or a rough location. The models provide parameters accumulated over time and location by one or more mobile devices and expected to work best for determining a position estimate.

### CROSS-REFERENCE TO RELATED APPLICATIONS

Not Applicable.

### BACKGROUND

I. Field of the Invention

This disclosure relates generally to apparatus and methods for wireless position location, and more particularly to position location based on historic positioning information.

II. Background

Some mobile devices compute position estimates based on current measurements while other mobile devices uses both current measurements and a short history of immediate computed solutions and trajectory information. Many mobile devices use least square (LS) approximations or Kalman filters (KF) solutions in computing position estimates. A difference between an LS solution and a KF solution resides in whether the mobile device uses previous user trajectory information. A mobile device using an LS algorithm calculates mobile position estimates based only on measurements from current time epoch. On the other hand, a mobile device using a KF algorithm combines measurements from the current time epoch with estimated previous mobile behavior (e.g., trajectory, velocity, and acceleration). To avoid influencing a current position estimate with an uncorrelated distant position estimate, a mobile device limits historical information to a window of time immediately preceding the current time and ignores all very old position estimates. Thus, the mobile device uses an immediate window of historical information but once used by the KF algorithm then discards the historical information forever afterwards. Even though a mobile device may determine a position estimate day after day at approximately the same position and approximately the same time, the historical information not in a window immediately preceding the current time is ignored. Thus, the mobile device generates a similar fix at a similar location independently without learning and without decreasing its error. This disconnection between history and a mobile device's current positioning misses an opportunity to adaptively improve future position estimates.

### BRIEF SUMMARY

In general, position estimates may be greatly improved by taking into account historical information occurring before the immediately preceding window of time, especially if a mobile device periodically repeats a route or resides in a common position (such as in an office during workdays or at home during night and weekends). In addition to position estimation, motion detection and context awareness may also be improved by techniques described herein.

Disclosed is an apparatus and method for determining a position of a mobile device based on expected user mobility. According to some aspects, disclosed is a method of determining a position of a mobile device based on expected user mobility, the method comprising: receiving, at the mobile device and from a server, a selected positioning method selected from a plurality of positioning methods, wherein the selected positioning method is selected based on the expected user mobility, and wherein the expected user mobility is based on at least one of a current rough position or a current time period; executing the selected positioning method; and determining a position estimate of the mobile device.

According to some aspects, disclosed is a mobile device for determining position of the mobile device, the mobile device comprising a processor and memory comprising code for: receiving, at the mobile device and from a server, a selected positioning method selected from a plurality of positioning methods, wherein the selected positioning method is selected based on the expected user mobility, and wherein the expected user mobility is based on at least one of a current rough position or a current time period; executing the selected positioning method; and determining a position estimate of the mobile device.

According to some aspects, disclosed is a mobile device for determining position of the mobile device, the mobile device comprising: means for receiving, at the mobile device and from a server, a selected positioning method selected from a plurality of positioning methods, wherein the selected positioning method is selected based on the expected user mobility, and wherein the expected user mobility is based on at least one of a current rough position or a current time period; means for executing the selected positioning method; and means for determining a position estimate of the mobile device.

According to some aspects, disclosed is a mobile device comprising a processor and a memory wherein the memory includes software instructions for: receiving, at the mobile device and from a server, a selected positioning method selected from a plurality of positioning methods, wherein the selected positioning method is selected based on the expected user mobility, and wherein the expected user mobility is based on at least one of a current rough position or a current time period; executing the selected positioning method; and determining a position estimate of the mobile device.

According to some aspects, disclosed is a non-transitory computer-readable storage medium including program code stored thereon, comprising program code for: receiving, at the mobile device and from a server, a selected positioning method selected from a plurality of positioning methods, wherein the selected positioning method is selected based on the expected user mobility, and wherein the expected user mobility is based on at least one of a current rough position or a current time period; executing the selected positioning method; and determining a position estimate of the mobile device.

It is understood that other aspects will become readily apparent to those skilled in the art from the following detailed description, wherein it is shown and described various aspects by way of illustration. The drawings and detailed description are to be regarded as illustrative in nature and not as restrictive.

### BRIEF DESCRIPTION OF THE DRAWING

Embodiments of the invention will be described, by way of example only, with reference to the drawings.

FIGS. 1 and 2 show a route between home and work for a first user and a grid pattern have spatial dimensions, in accordance with some embodiments of the present invention.

FIGS. 3 to 8 show two-dimensional grids composed of different sized areas, in accordance with some embodiments of the present invention.

FIGS. 9 and 10 show a grid pattern having a temporal dimension, in accordance with some embodiments of the present invention.

FIGS. 11 to 16 show routing on a grid pattern.

FIGS. 17 to 19 show communications between a mobile device and an assistance server, in accordance with some embodiments of the present invention.

FIG. 20 shows an example timeline, in accordance with some embodiments of the present invention.

FIG. 21 shows positioning estimation, in accordance with some embodiments of the present invention.

FIG. 22 shows a wireless communication network, in accordance with some embodiments of the present invention.

### DETAILED DESCRIPTION

The detailed description set forth below in connection with the appended drawings is intended as a description of various aspects of the present disclosure and is not intended to represent the only aspects in which the present disclosure may be practiced. Each aspect described in this disclosure is provided merely as an example or illustration of the present disclosure, and should not necessarily be construed as preferred or advantageous over other aspects. The detailed description includes specific details for the purpose of providing a thorough understanding of the present disclosure. However, it will be apparent to those skilled in the art that the present disclosure may be practiced without these specific details. In some instances, well-known structures and devices are shown in block diagram form in order to avoid obscuring the concepts of the present disclosure. Acronyms and other descriptive terminology may be used merely for convenience and clarity and are not intended to limit the scope of the disclosure.

Position determination techniques described herein may be implemented in conjunction with various wireless communication networks such as a wireless wide area network (WWAN), a wireless local area network (WLAN), a wireless personal area network (WPAN), and so on. The term “network” and “system” are often used interchangeably. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, Long Term Evolution (LTE), and so on. A CDMA network may implement one or more radio access technologies (RATs) such as cdma2000, Wideband-CDMA (W-CDMA), and so on. Cdma2000 includes IS-95, IS-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. A WLAN may be an IEEE 802.11x network, and a WPAN may be a Bluetooth network, an IEEE 802.15x, or some other type of network. The techniques may also be implemented in conjunction with any combination of WWAN, WLAN and/or WPAN.

A satellite positioning system (SPS) typically includes a system of transmitters positioned to enable entities to determine their location on or above the Earth based, at least in part, on signals received from the transmitters. Such a transmitter typically transmits a signal marked with a repeating pseudo-random noise (PN) code of a set number of chips and may be located on ground based control stations, user equipment and/or space vehicles. In a particular example, such transmitters may be located on Earth orbiting satellite vehicles (SVs). For example, a SV in a constellation of Global Navigation Satellite System (GNSS) such as Global Positioning System (GPS), Galileo, GLONASS or Compass may transmit a signal marked with a PN code that is distinguishable from PN codes transmitted by other SVs in the constellation (e.g., using different PN codes for each satellite as in GPS or using the same code on different frequencies as in GLONASS). In accordance with certain aspects, the techniques presented herein are not restricted to global systems (e.g., GNSS) for SPS. For example, the techniques provided herein may be applied to or otherwise enabled for use in various regional systems, such as, e.g., Quasi-Zenith Satellite System (QZSS) over Japan, Indian Regional Navigational Satellite System (IRNSS) over India, Beidou over China, etc., and/or various augmentation systems (e.g., an Satellite Based Augmentation System (SBAS)) that may be associated with or otherwise enabled for use with one or more global and/or regional navigation satellite systems. By way of example but not limitation, an SBAS may include an augmentation system(s) that provides integrity information, differential corrections, etc., such as, e.g., Wide Area Augmentation System (WAAS), European Geostationary Navigation Overlay Service (EGNOS), Multi-functional Satellite Augmentation System (MSAS), GPS Aided Geo Augmented Navigation or GPS and Geo Augmented Navigation system (GAGAN), and/or the like. Thus, as used herein an SPS may include any combination of one or more global and/or regional navigation satellite systems and/or augmentation systems, and SPS signals may include SPS, SPS-like, and/or other signals associated with such one or more SPS.

As used herein, a mobile device, sometimes referred to as a mobile station (MS) or user equipment (UE), such as a cellular phone, mobile phone or other wireless communication device, personal communication system (PCS) device, personal navigation device (PND), Personal Information Manager (PIM), Personal Digital Assistant (PDA), laptop or other suitable mobile device which is capable of receiving wireless communication and/or navigation signals. The term “mobile station” is also intended to include devices which communicate with a personal navigation device (PND), such as by short-range wireless, infrared, wireline connection, or other connection—regardless of whether satellite signal reception, assistance data reception, and/or position-related processing occurs at the device or at the PND. Also, “mobile station” is intended to include all devices, including wireless communication devices, computers, laptops, etc. which are capable of communication with a server, such as via the Internet, WiFi, or other network, and regardless of whether satellite signal reception, assistance data reception, and/or position-related processing occurs at the device, at a server, or at another device associated with the network. Any operable combination of the above are also considered a “mobile station.”

Some embodiments of the present invention enhance known KF implementations by using a history of mobile trajectory. Instead of discarding positioning results, all or part of a mobile device's motion information is used. Positioning information may include estimated position, trajectory, velocity and acceleration (along with the associated error estimates of each). The positioning information may also include an indication of the set of positioning sensors used (e.g., accelerometer, gyroscope and/or GPS). The positioning information may also include an indication of which positioning methods were used (e.g., within just mobile or assisted by a server).

The positioning information is stored as historical information and/or accumulated history locally to memory of the mobile device itself and/or remotely to a server, such as an assistance server. This historical information may be indexed spatially or geographically (e.g., using a grid shaped square or cellular coverage areas) and/or may be indexed temporally (e.g., using time of day (TOD), time of week (TOW), and time of year (TOY) divisions). The historical information is accumulated over time as accumulated history to form a behavior model. If stored and accumulated locally, the behavior model models that mobile device. If stored and accumulated remotely, the behavior model may model either or both the particular mobile device and all mobile devices in a community.

The behavior model may be index in one or more fashions separately or concurrently. Two indexing methods described above are spatial and temporal indexing. For example, a behavior model may hold information for a particular rough area independent of time. Alternatively or separately, a behavior model may hold information for a time span independent of location. Still, a behavior model may hold information indexed by and relevant to a combination of a particular time span and a rough area. An overall behavior model may be indexed in multiple manners.

For example, an overall behavior model may be indexed by just an area, which includes a rough location of a mobile device, to retrieve accumulated history for all historical information associated with that area. The same overall behavior model may be indexed from just the current time to retrieve accumulated history for all historical information associated with a span of time that includes the current time. The same overall behavior model may be indexed by both area and a time span to retrieve accumulated history for all historical information associated with a rough location and a current time of the mobile device.

A current time and/or a mobile device's rough location may be converted to an index or indices pointing to a histogram. The histogram may contain velocities for the mobile device at a similar rough location (e.g., within the same cell) and/or a similar time (e.g., during working hours on a weekday). Alternatively or in addition to, a histogram may contain a typical speed (e.g., stationary, slow walking, fast walking, and driving) for a similar time and/or similar location. For example, a time falling within a morning commute hour for a user of the mobile device may index into a table showing a typical commute speed and direction for this user and/or a certain route along which the user most often travels. Alternatively, a time and/or a rough location may be converted to indices pointing to a typical location for that time or rough location. For example, a rough location falling within a grid may be used to lookup a typical and precise location often associated with the user along with a typical uncertainty radius. The location may be a location of a user's home and an associated uncertainty may be tens of feet. For a different rough location, the precise location may be a user's office, a frequently visited store or a favorite restaurant frequented by the user. In each case, the positioning information from the behavior model may be used to seed a positioning algorithm with values assuming the looked up information is the current information. In this manner, the behavior model is indexed when the mobile device revisits a corresponding space and/or time grid to assist in determining a current position estimate. Once determined, a computed position estimate and algorithm parameters may be recorded and/or used to update the behavior model.

While the description of the historical information above focuses on position accuracy improvement for navigation, this disclosure is applicable to recording and reusing variables at the measurement and positioning levels. For example, a mobile device may record an integration time of a GPS channel for a successfully acquired channel and reuse this recorded value for faster and more reliable acquisition if the mobile revisits the same time and/or space grid.

The behavior model may be described with a time period (e.g., a day of the week and/or a time of the year) to reflect periodic behavior from one day to another day (e.g., from a Sunday to a Monday, or from tomorrow to today), workday to workday, a weekend to weekend (e.g., every Saturday), a week to week, a year to year (e.g., Independent's Day to Independent's Day), etc.

An assistance server may be used to aggregate histories of multiple mobile devices to generate a public model. The public model common to all users may be used with a mobile device's private model specific to a particular mobile device as a seed to populate the private model from the public model. The behavior model may contain parameters useful to initialized receiver states on the mobile device when the mobile device revisits at a periodic time to the coarse time (e.g., a subsequent commute hour) or when the mobile device revisits a rough location. This is, the mobile device using historical information from a previous visit to a periodic time and/or revisits a rough location (e.g., an intersection passed each day).

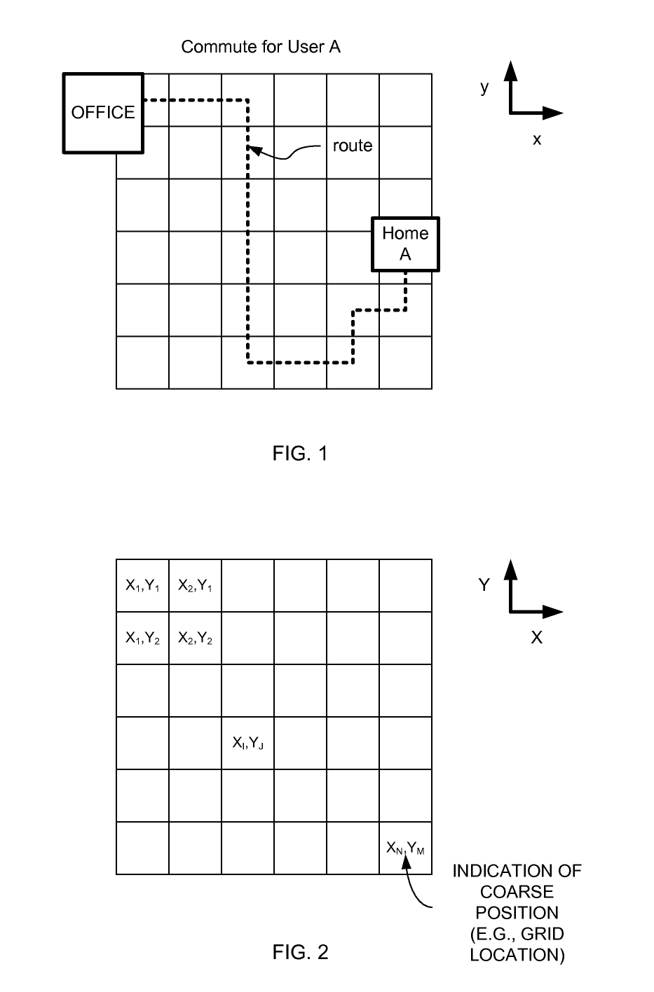

FIGS. 1 and 2 show a route between home and work for a first user and a grid pattern have spatial dimensions, in accordance with some embodiments of the present invention. A city or other region may be mapped out in grids (6 by 6 grids are shown). In FIG. 1, an office is shown at a first grid location and a home is shown at a second grid location. As shown, the commuter (user A) travels along a similar route between home and the office. In FIG. 2, the grid pattern is indexed along two axes: the X axis is indexed by {X₁, . . . , X_{I}, . . . , X_{N}}, and the Y axis is indexed by {Y₁, . . . , Y_{J}, . . . , Y_{M}}. Each grid location (X_{I}, Yⱼ) represents a rough position and indexes into a historical model to provide historical information, such as a typical position, typical speed, typical traveling direction, typical speed, and/or typical algorithm parameters used during previous successful location attempts.

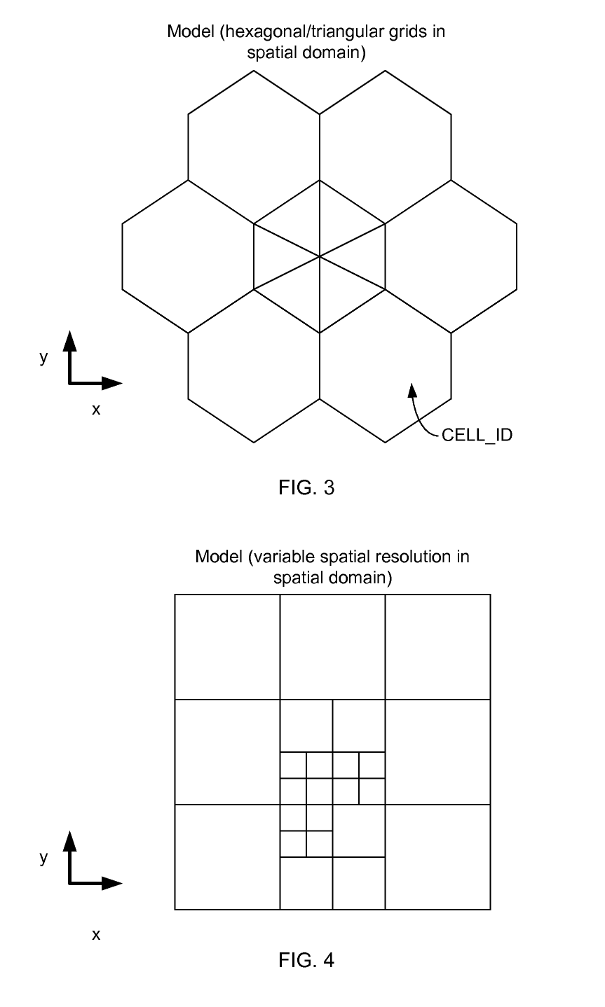

FIGS. 3 to 8 show two-dimensional grids composed of different sized areas, in accordance with some embodiments of the present invention. The grid pattern described above consisted of similar sized squares covering equal areas. In FIG. 3, areas are defined by sectors and cells of base stations (e.g., BSSs, BTSs or access points). In this example a center cell is sectioned into six sectors and a outer ring of unsectorized cells surround the sectorized cell. In this model, each sector and cell represents a separate grid location as either a hexagon or a triangle. The sectors and cells may be indexed by a center location or by a Cell ID and/or Sector ID.

In FIG. 4, a grid pattern consists of different sized squares. The squares may be less dense in areas where less activity exists or is expected and more dense in other areas where more activity exists. The grid pattern may be static or dynamic. If static, the grid pattern is initially configured with certain sized grids and these grids remain the same size. If dynamic, the grids may subdivide when the volume of user data warrants it and combine when a pair or more of grids lack a volume of user data.

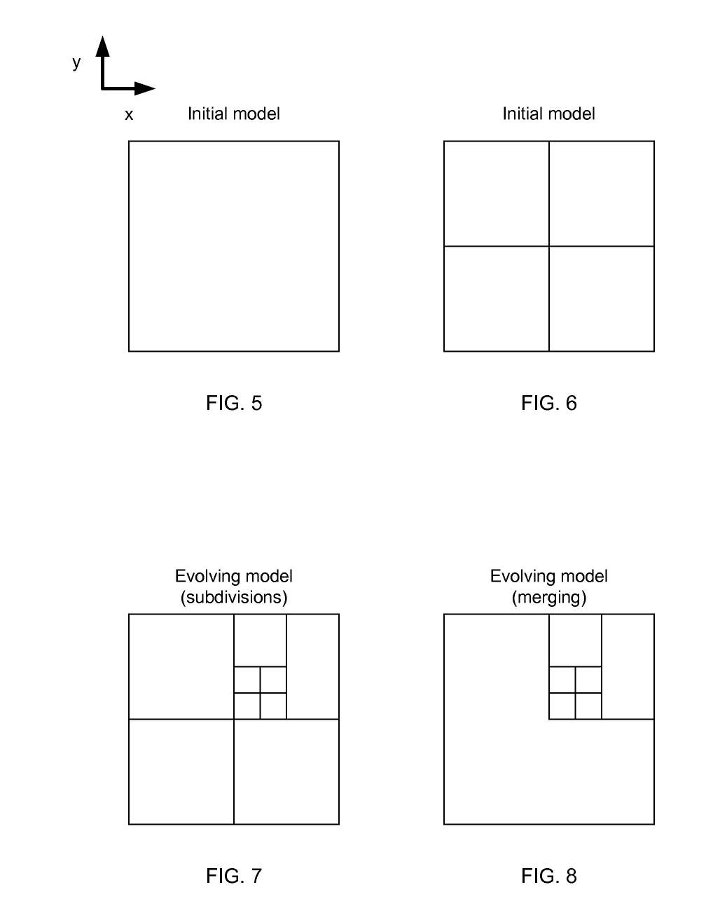

FIGS. 5-8 illustrate a dynamic grid pattern of grids subdividing and combining. In FIG. 5, a grid pattern consists of a single grid location. As user data is collected, a grid pattern may subdivide into two or more (e.g., with one grid subdividing into four separate grid locations as shown in FIG. 6). When a volume of user data warrants it, a divided grid may subdivide again and again as shown in FIG. 7 where a square grid subdivided into two rectangular grids. One of the rectangular grids subdivided into two smaller square grids then into four even smaller grids based on an increased volume of user data. For example, a highly divided grid location may indicate a location of a area frequently visited, such has home, work or a mall, or a route between such fixed locations. In FIG. 8, unfrequented grid are combined. For example, three of the four grids formed in FIG. 6 are recombined to form an ‘L’ shaped grid. With time, various grids may repeatedly subdivide and combine to balance a volume of data represented by each grid until a steadstate grid map is derived. For example, a large grid represents a first area (e.g., farm land) not frequented by a user, while a small grid represents an area (e.g., downtown) frequently visited by the user.

Grids shown and described above are indexed by spatial values. Grids may be indexed by temporal values or indexed both by spatial and temporal values as described below.

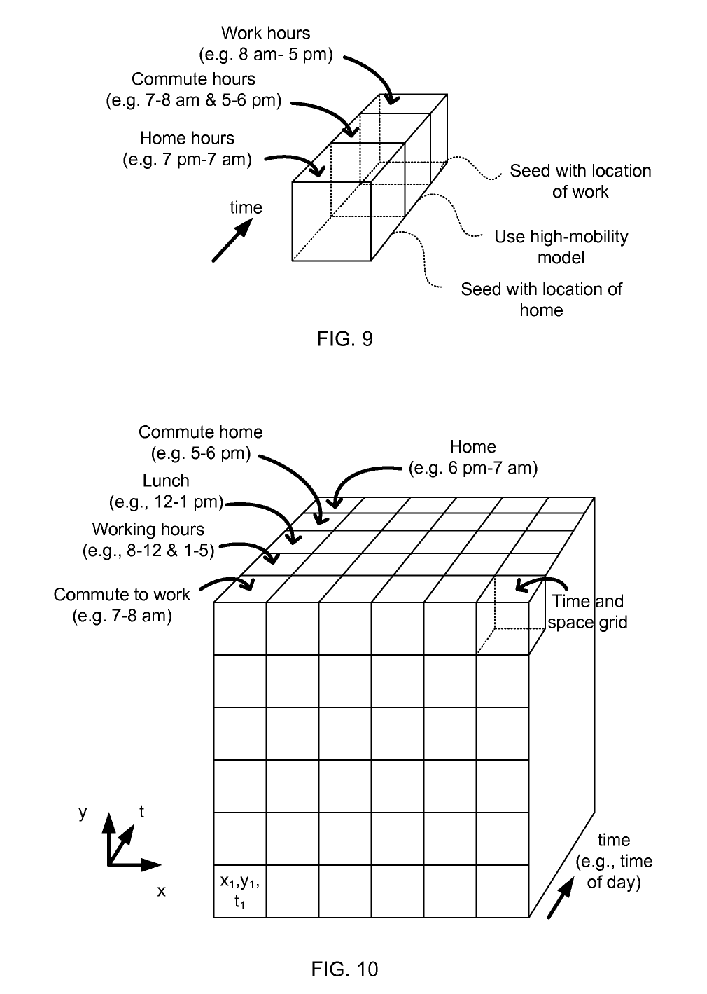

FIGS. 9 and 10 show a grid pattern having a temporal dimension, in accordance with some embodiments of the present invention. In FIG. 9, grids are divided by time. For example, three grids may be defined that represent home hours (e.g., 7 PM to 7 AM), commute hours (e.g., 7 AM to 8 AM and 5 PM to 6 PM) and work hours (e.g., 8 AM to 5 PM). The grid pattern may be subdivided further for lunch hours and to contrast weekend days from weekdays. A current time may be quantized into one of the indexed periods. Each grid location may contain historical data from previous successful fixes. For example, a grid representing home hours may contain a seed location of the home's GPS location and an appropriate integration interval. A grid representing commute hours may indicated that a high-mobility model should be used. A grid representing work hours may be seeded with location of the office's GPS location and an appropriate integration interval.

In FIG. 10, a grid pattern is shown having both spatial and temporal indices, thereby inter-mixing the grid patterns of FIGS. 2 and 9. Each box is a time and space grid that represents a time period and a rough area and may be indexed by spatial and temporal variables (e.g., (xᵢ, yⱼ, tₖ) or (cell_idᵢ, tₖ)). Each grid location may contain public historical information (representing, in the aggregate, mobile devices) and/or private historical information (representing a particular mobile device) during that period and rough location.

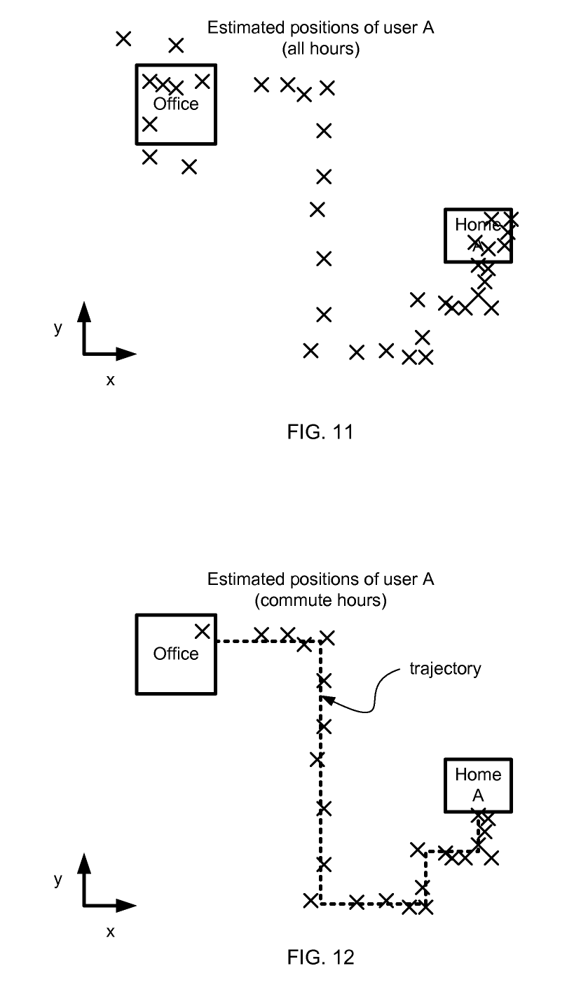

FIGS. 11 to 16 show routing on a grid pattern. In FIG. 11, multiple position estimates are shown for all hours during a particular timespan (e.g., a day, week or month) for a particular mobile device, labeled as user A. The position estimates are clustered around Home A, which is the home of user A and around the Office of user A. The position estimates are also dotted along a route between home and the office for user A.

In FIG. 12, a mobile device or a server may collect position estimates made over time. For example, a mobile device may collect and record position estimates during one or more commute hours or one or more days. The mobile device (or server) may use the collection of position estimates for user A to formulate a trajectory. The trajectory may be used in the future to convert a rough position into a seed position along the trajectory that is closest to the trajectory.

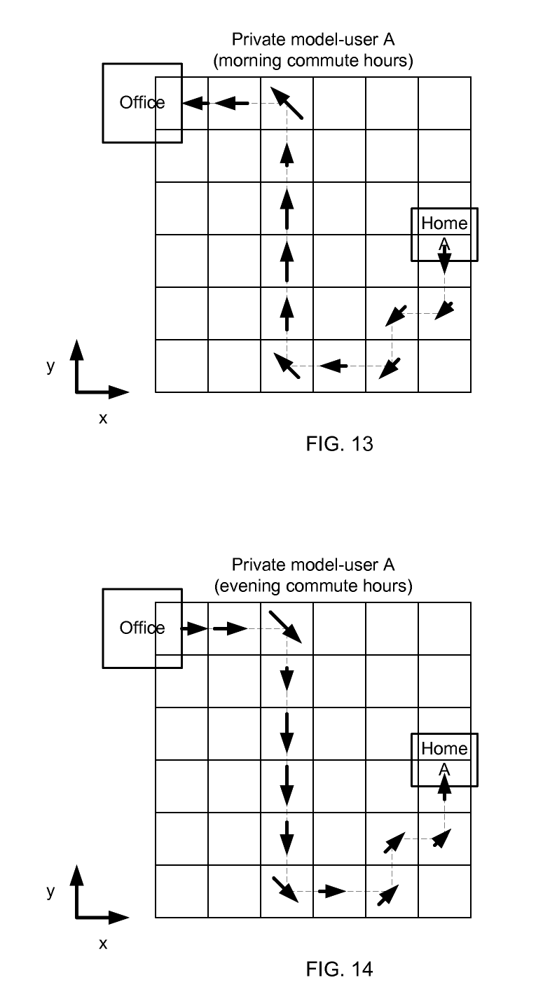

In FIG. 13, a grid pattern holds historical information for a first user (user A) during previous one or more morning commute hours. In the example shown, user A commutes from home to the office during morning commute hours. Multiple morning commutes may be accumulated from day to day to several weeks or longer to show a trend of morning commutes for the user ignoring aberrations not falling along the trajectory. In FIG. 14, a second grid pattern holds historical information for user A during previous one or more evening commute hours. Again, several evening commutes may be accumulated. In the example shown, user A commutes from the office to home during evening commute hours along a similar trajectory. A rough position falling within one of the grid locations along the commute grids or trajectory would return a seed position and/or seed velocity and/or parameters for a position estimate engine (e.g., previously acceptable integration time).

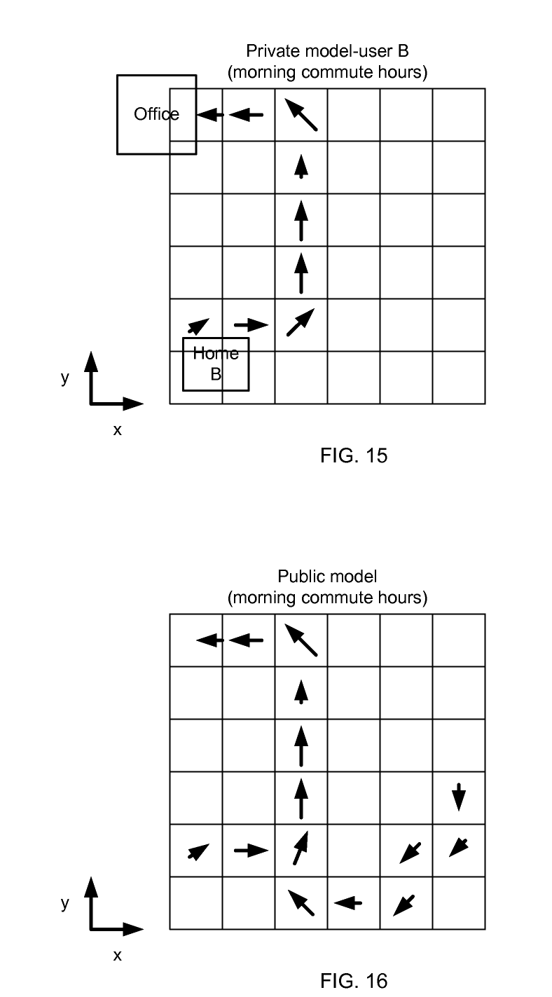

In FIG. 15, a grid pattern holds historical information for a second user (user B) during previous one or more morning commute hours. In the example shown, user B commutes from a second home location to the office during morning commute hours.

When historical information references a particular user (e.g., user A as explained above), a model holding such historical information may be referred to as a private model. On the other hand, when historical information references a group of users in the aggregate, a model holding such historical information may be referred to as a public model.

In FIG. 16, a grid pattern holds historical information for multiple users (e.g., users A and B) during previous one or more morning commute hours. Similarly, multiple morning commutes may be accumulated from a previous day or longer to show a trend of commutes for the users. This historical information may be stored to a grid location for a public model.

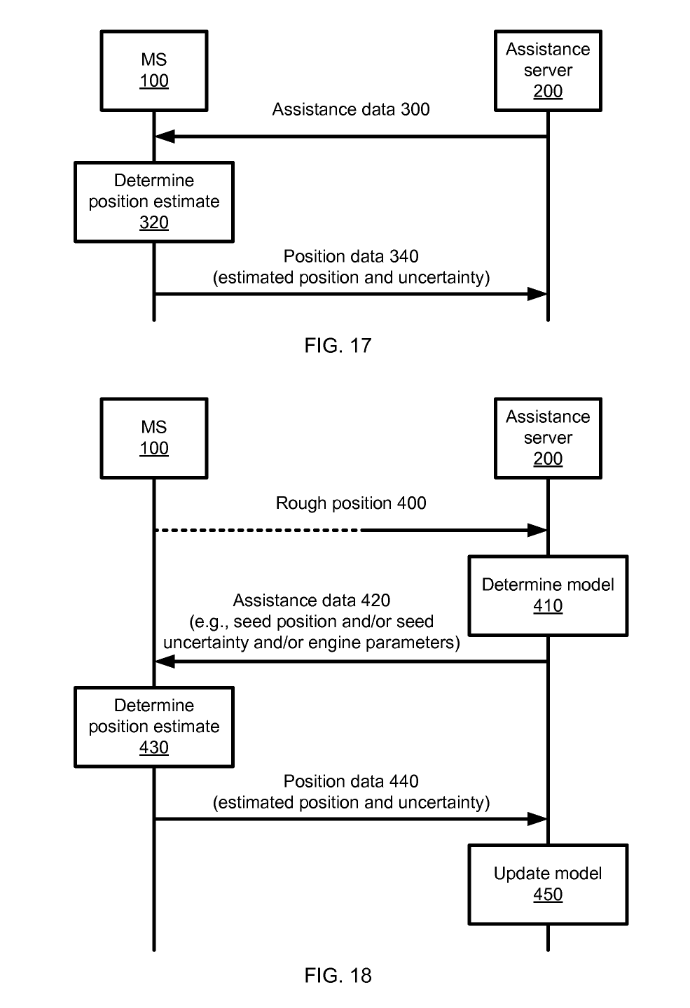

FIGS. 17 to 19 show communications between a mobile device and an assistance server, in accordance with some embodiments of the present invention.

In FIG. 17, a known system is shown with an assistance server 200 providing assistance data 300 to MS100. At 320, MS100 determines its position estimate. Once determined, the MS100 sends position data 340 (including an estimated position and uncertainty) back to the assistance server 200. In this scenario, the assistance server 200 does not provide a seed position, seed uncertainty or positioning engine parameters to MS100.

In FIG. 18, MS100 and an assistance server 200 work together to determine an improved position estimate based on at least a rough position. The assistance server 200 determines a rough position for MS100. This determination may be the result of MS100 sending its rough position 400 to the assistance server 200. Alternatively, the assistance server 200 may determine a rough position of MS100 indirectly of MS100. For example, the assistance server 200 may determine a rough position from the network based on a cell where the MS100 is registered. Alternately, the assistance server 200 may determine a rough position from the network based on triangulation or trilateration by multiple network receivers.

In some cases, only private models exists. In other cases, only public models exists. Still in other cases, a determination between public and private models is made. For example, at 410, the assistance server 200 determines which model to use. If an adequate private model exists for the user of MS100, that private model may be used. If not, a public model may be used. The assistance server 200 responds with assistance data 420 to MS100. The assistance data 400 includes extra one or more extra parameters such as a seed position and/or a seed uncertainty and/or one or more positioning engine parameters from the model.

At 430, MS100 determines its position estimate based on the extra parameter(s) in the assistance data message 420. Once determined, the MS100 sends position data 440 (including a position estimate and uncertainty) back to the assistance server 200. MS100 may also send one or more positioning engine parameters to the assistance server 200. At 450, the assistance server 200 updates the private and/or public models with the determined position and/or its uncertainty and/or the one or more positioning engine parameters.

In the embodiments described above, the assistance server 200 provides an assistance data message 420 with an extra one or more parameters based on a rough location of MS100. Alternatively, the assistance server 200 may base the extra data on a coarse current time to find a grid location. In some embodiments, an assistance server 200 may base the extra data on both a rough position and a coarse current time. The current time may be quantized to find a coarse time that represents a periodic period (e.g., every morning commute hour, every weekend day, Mondays, each Sunday morning, or an annual holiday).

In still other embodiments, the function of generating the extra data occurs in MS100 rather than in a separate assistance server 200. In these cases, MS100 includes historical information in a private model and/or a public model, which is indexed by a rough position and/or a coarse current time. MS100 uses its rough position and/or a coarse current time to access a grid in a private or public model. This method does not necessarily exclude receiving known assistance data 300 from an assistance server 200 but such assistance data may be used in tandem with historical information from the model. In such a manner, MS100 may find an enhanced position estimate in an unmodified or known network with modifications just to code with MS100.

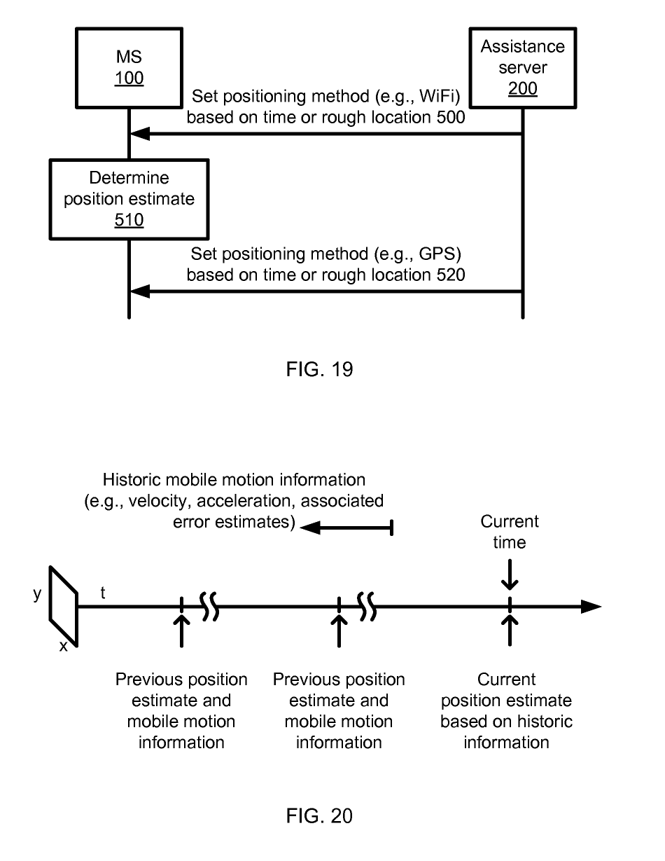

In FIG. 19, an assistance server 200 aids MS100 in determining a position estimate. The assistance server 200 instructs MS100 of a particular positioning method to use. The assistance server 200 sends and defines a first positioning method in message 500. For example, based on a rough position and/or a coarse time, the assistance server 200 instructs MS100 to first use a WiFi-based positioning method. In some cases, the indicated positioning method is part of an assistance data message (similar to message 420). In other cases, the indicated positioning method is sent from the assistance server 200 to MS100 separate from an assistance data.

At 510, MS100 determines a position estimate based on the indicated positioning method as instructed in message 500. If unsuccessful, MS100 may attempt to use another positioning method. In any case, MS100 reports back to the assistance server 200 with positioning data (e.g., described above as message 340 or 440). The positioning data may also include a success or failure indication. That is, MS100 may tell the assistance server 200 which one or more positioning methods did not successfully produce an adequate position estimate and/or which one or more positioning methods did an adequate position estimate. The assistance server 200 treats the received success and/or failure results as historical information to enter into a current grid based on the coarse time and/or rough location. As shown with message 520, the assistance serve 200 may use this updated success/failure indication to instruct MS100 to use the original or a second positioning method. For example, the assistance server 200 may instruct MS100 to now use a GPS positioning method (rather than a WiFi-based method) on a next visit to a coarse time and/or rough position.

The first and second positioning may each include a single positioning method or may contain a small set of positioning methods. Furthermore, the positioning methods may be rank is a desired order (e.g., first try WiFi then try GPS then try AGPS). The positioning methods include Enhanced Observed Time Difference (E-OTD), Observed Time Difference of Arrival (OTDOA), Observed Time Difference of Arrival-Idle Period on DownLink (OTDOA-IPDL), Assisted GPS (A-GPS), Advanced Forward Link Trilateration (A-FLT), reverse link trilateration, triangulation, WiFi and/or Cell ID among others.

FIG. 20 shows an example timeline, in accordance with some embodiments of the present invention. One or more previous position estimates are collected as historical information for MS100. The position estimates may be augmented with mobile motion information from one or more position sensors. This motion information may include velocity, acceleration and associated uncertainty or error estimates. The position sensors may include a GNSS sensor, an accelerometer and/or a gyrometer. The historical information is saved to a grid for the particular coarse time and/or rough position. At a current time disjointed from the previous occurrence of the periodic coarse time or a current position disjointed from the previous occurrence of the rough location, a current grid is accessed to retrieved accumulated historical information. Unlike known systems, embodiments described herein use historical information disjointed from a current time or current location, whereas known systems relied on immediately preceding position estimates before a mobile device has had a change to move a substantial distance.

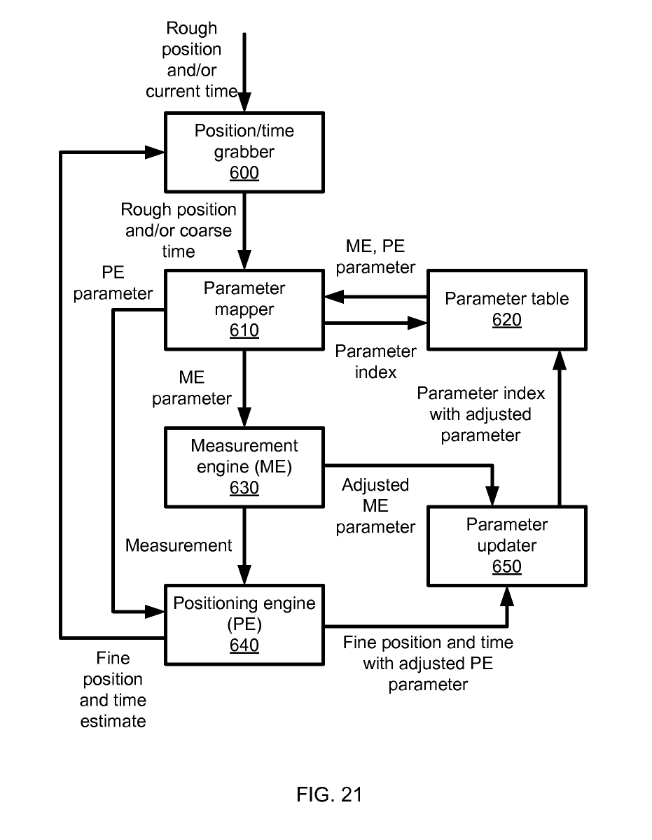

FIG. 21 shows positioning estimation, in accordance with some embodiments of the present invention. Positioning estimation hardware and/or software, which may reside in MS100 and/or the assistance server 200, includes a position/time grabber 600, a parameter mapper 610, a parameter table 620, a measurement engine (ME) 630, a positioning engine (PE) 640 and a parameter updated (650). The position/time grabber 600 receives a rough position and/or a current time. The current time may be converted into a coarse time, which represents a periodic duration. The position/time grabber 600 may also receive a fine position and/or time estimate as a feedback signal from PE 640. The position/time grabber 600 outputs a rough position and/or coarse time to be used by the parameter mapper 610.

The parameter mapper 610 uses the rough position and/or coarse time to create an index into the parameter table 620. Specifically, the parameter mapper 610 links the notion of position and time to the stored ME and PE parameters. By converting position and time into a corresponding index to the parameter table, the parameter mapper 610 obtains proper ME and PE parameters accumulated over previous sessions. The extraction of corresponding parameters may depend on the expected accuracy of given position and time information. For example, if the positioning accuracy is 10 km, the extracted parameter could be representative of the corresponding size of area (either combinations of parameters within the area or potentially multiple sets of parameters). The parameter mapper 610 accesses the parameter table 620, which holds the historical information, based on an index or indices formed from the current rough position and/or current time. In response, the parameter table 620 returns one or more parameters (i.e., one or more ME parameters, one or more PE parameters, or both ME and PE parameters).

The parameter table 620 may return an empty set of ME and PE parameters, a single set of ME and PE parameters, or multiple sets of ME and PE parameters. In the case that an empty set is returned, the parameter mapper 610 may pass along default values or an indication for the ME 630 and PE 640 to use default values. In the simple case that a single set is returned from the parameter table 620, the parameter mapper 610 may forward these ME and PE parameters to the ME 630 and PE 640. In a case where the parameter table 620 returns multiple sets of ME and PE parameters, the parameter mapper 610 may combine or join these ME and PE parameters into a single set of ME and PE parameters forwarding to the ME 630 and PE 640. Alternatively, the ME 630 and PE 640 may accept the multiple sets of ME and PE parameters and either try each set separately or selectively combine parameters.

The parameter mapper 610 forwards any ME parameter(s) to ME 630 and any PE parameter(s) to PE 640. ME parameters include parameters used during a measurement phase. ME parameters include any one or more of measurement types (e.g., GPS range, WiFi RSSI, AFLT, CellID, INS), signal availability (with an indication of success or failure), signal acquisition time, signal to noise ratio (SNR), number of observed ranging sources, signal integration time, estimated ranging errors, applied thresholds (e.g., SNR and elevation thresholds). PE parameters include parameters used by a positioning engine. PE parameters may include any one or more of sensors to use (e.g., GPS and/or WiFi), seed values, initial Kalman filter (KF) parameters, a set of positioning sensors (e.g. GPS+WiFi) used in a positioning solution (e.g., GPS, WiFi, AFLT, CellID, INS) within distinction among delivered and actually used ones, estimated position and time errors, and final positioning results (e.g., position, velocity, acceleration, time) expressed in either an absolute coordinate system (e.g., WGS84) or in a relative coordinate system with a reference point. For example, the median or mean mobile location, or more simply home can be used as reference point. Then, the rest of mobile locations can be expressed in offsets from this reference point for compact data storage. The offsets can be in latitude, longitude, and altitude (LLA) or east, north, up (ENU). The PE parameters may also include an applied or assumed mobility model in the positioning engine, which assumes certain ranges of velocity and acceleration. The mobility model states may include: stationary, slow walking, fast walking and driving.

ME 630 uses any ME parameters received to gain a head start with measurements. Without the ME parameters, ME 630 would be running in a cold start mode or with access to just the immediately preceding location data. After a successful measurement or a successful position estimation, ME 630 forwards updated ME parameters to the parameter updater 650.

PE 640 uses any PE parameters received also to gain a head start with position estimate. As a result, position estimation is expected to occur more rapidly. For example, previously unsuccessful methods or parameters may be replaced with methods and parameters expected to be more successful. PE 640 informs the parameter updated 650 with a determined position (referred to as a fine position or a refined position). PE 640 may also inform the parameter updater 650 with adjusted PE parameters.

The parameter updater 650 updates the parameter table 620 with adjusted parameters received from ME 630 and PE 640 such that the parameter table 620 is updated by aggregating existing entry or entries with the adjusted parameters to fine tune the parameter table 620. The accumulated parameters may be stored without processing. Alternatively, parameters statistics may be extracted and stored for compact storage. For example, histogram, minimum value, maximum value, mean, median value, standard deviation, and/or a representative percentile values (50%, 65%, 95%) may be stored for each parameters. For tracking of statistical significance, the number of data points, probability of occurrence, and standard deviation may be maintained for description of statistical distribution.

The parameter table 620 holds historical data learned over several periods for grid locations indexed by rough position and/or coarse time. In this manner, position estimation adaptively learns based on historical information.

In some embodiments, the position grabber 600, parameter mapper 610, ME 630 and PE 640, as well as the parameter table 620 and parameter updated 650 all reside in MS100. In other embodiments, as described below, the position grabber 600, parameter mapper 610, ME 630 and PE 640 reside in MS100 and the parameter table 620, and parameter updated 650 reside in a server, such as the assistance server 200.

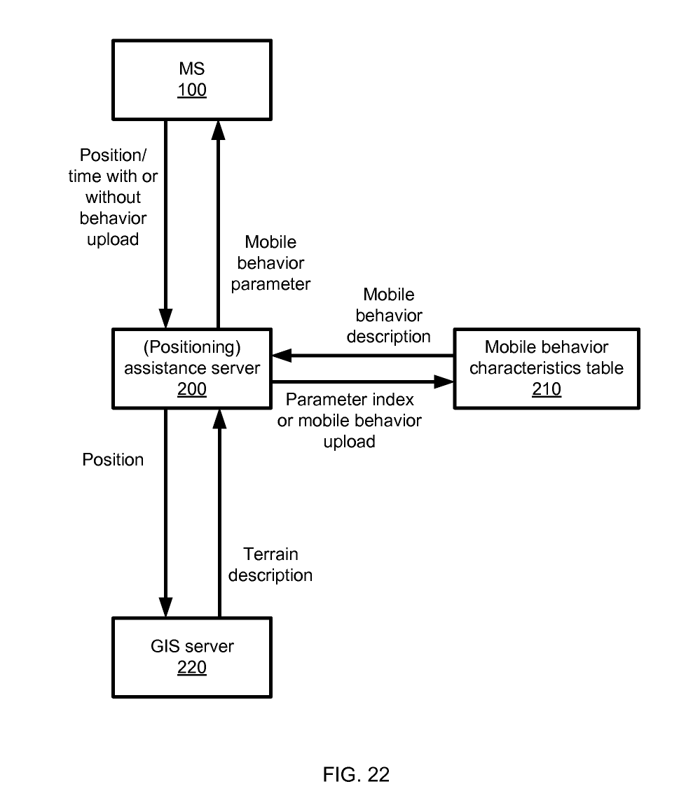

FIG. 22 shows a wireless communication network, in accordance with some embodiments of the present invention. The wireless communication network includes MS100, an assistance server 200, a table of mobile behavior 210 and a GIS server 220. The assistance server 200 provides MS100 with mobile behavior parameters, referred above as accumulated historical information from a public model and/or a private model. MS100 uses the mobile behavior parameters (one or more ME parameters and/or one or more PE parameters) to enhance position estimation. MS100 may report a current position estimate to the assistance server 200. MS100 may report what positioning method or methods worked and what positioning method or methods failed to produce an adequate position estimate. MS100 may also report back uncertainty calculations, ranging errors and other ME and PE parameters for the assistance server 200 to collect and accumulate in a private model for that MS and/or public model generally for all MSs without a private model. The assistance server 200 saves parameter index by coarse time and/or rough location to table 210. When needed for subsequent MSs, the assistance server 200 accesses table 210 for ME and PE parameters for MS100 based on a subsequent coarse time and/or subsequent rough location. The assistance server 200 may also use the GIS server 220 to find a terrain description based on a rough position. Alternatively, table 210 may be set or updated based on a terrain description for a particular rough location. For example, a particular rough location may indicate an urban environment. The assistance server 200 may use this information to set a positioning method and/or parameters best for the discovered terrain.

The methodologies described herein may be implemented by various means depending upon the application. For example, these methodologies may be implemented in hardware, firmware, software, or any combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory and executed by a processor unit. Memory may be implemented within the processor unit or external to the processor unit. As used herein the term “memory” refers to any type of long term, short term, volatile, nonvolatile, or other memory and is not to be limited to any particular type of memory or number of memories, or type of media upon which memory is stored.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims. That is, the communication apparatus includes transmission media with signals indicative of information to perform disclosed functions. At a first time, the transmission media included in the communication apparatus may include a first portion of the information to perform the disclosed functions, while at a second time the transmission media included in the communication apparatus may include a second portion of the information to perform the disclosed functions.

The previous description of the disclosed aspects is provided to enable any person skilled in the art to make or use the present disclosure. Various modifications to these aspects will be readily apparent to those skilled in the art, and the generic principles defined herein may be applied to other aspects without departing from the spirit or scope of the disclosure.

What is claimed is:

1. A method of determining a position of a mobile device based on expected user mobility, the method comprising:
receiving, at the mobile device and from a server, a selected positioning method selected from a plurality of positioning methods, wherein the selected positioning method is selected based on the expected user mobility, and wherein the expected user mobility is based on at least one of a current rough position or a current time period;
executing the selected positioning method; and
determining a position estimate of the mobile device.

2. The method of claim 1, wherein the selected positioning method is selected further based on at least one of a trajectory, a velocity, an acceleration or an associated estimator error.

3. The method of claim 1, wherein the plurality of positioning methods comprise:
Observed Time Difference of Arrival (OTDOA) and
Assisted GPS (A-GPS).

4. The method of claim 1, wherein the selected positioning method is selected based on the current rough position.

5. The method of claim 4, wherein the rough position represents a geographical area.

6. The method of claim 4, wherein the rough position represents a grid location.

7. The method of claim 1, wherein the rough position comprises a cellular base station identifier (CELL_ID).

8. The method of claim 1, wherein the rough position indexes a record in a database on the server, wherein the record contains the selected positioning method.

9. The method of claim 1, wherein the selected positioning method is selected based on the current time period.

10. The method of claim 9, wherein the current time period comprises a period of a day (POD).

11. The method of claim 10, wherein the period of a day distinguished among an at-home period, a commuting period, and a working period.

12. The method of claim 9, wherein the current time period comprises a day of the week (DOW).

13. The method of claim 12, wherein the current time period distinguished between a workday and a weekend.

14. The method of claim 9, wherein the current time period comprises a day of the year (DOY).

15. The method of claim 1, further comprising sending, from the mobile device to the server, the rough position prior to receiving the selected positioning method.

16. The method of claim 1, further comprising sending, from the mobile device to the server, a request for the selected positioning method.

17. A method of determining a position of a mobile device based on expected user mobility, the method comprising:
providing current parameters after completion of a positioning method, the current parameters for accumulation and storage as historical information indexed by at least one of a coarse time or a rough location;
separating from the at least one of the coarse time or the rough location after providing the current parameters;
revisiting the at least one of the coarse time at a subsequent period or the rough location;
indexing the historical information using the least one of the coarse time or the rough location to retrieve at least one accumulated parameter; and
computing a position estimate using the retrieved at least one accumulated parameter.

18. A mobile device for determining position of the mobile device, the mobile device comprising a processor and memory comprising code for:
receiving, at the mobile device and from a server, a selected positioning method selected from a plurality of positioning methods, wherein the selected positioning method is selected based on the expected user mobility, and wherein the expected user mobility is based on at least one of a current rough position or a current time period;
executing the selected positioning method; and
determining a position estimate of the mobile device.

19. A mobile device for determining position of the mobile device, the mobile device comprising:
means for receiving, at the mobile device and from a server, a selected positioning method selected from a plurality of positioning methods, wherein the selected positioning method is selected based on the expected user mobility, and wherein the expected user mobility is based on at least one of a current rough position or a current time period;
means for executing the selected positioning method; and
means for determining a position estimate of the mobile device.

20. A mobile device comprising a processor and a memory wherein the memory includes software instructions for:
receiving, at the mobile device and from a server, a selected positioning method selected from a plurality of positioning methods, wherein the selected positioning method is selected based on the expected user mobility, and wherein the expected user mobility is based on at least one of a current rough position or a current time period;
executing the selected positioning method; and
determining a position estimate of the mobile device.

21. A non-transitory computer-readable storage medium including program code stored thereon, comprising program code for:
receiving, at the mobile device and from a server, a selected positioning method selected from a plurality of positioning methods, wherein the selected positioning method is selected based on the expected user mobility, and wherein the expected user mobility is based on at least one of a current rough position or a current time period;
executing the selected positioning method; and
determining a position estimate of the mobile device.
